(19) United States
(12) Patent Application Publication
(10) Pub. No.: US 2020/0159240 A1
(43) Pub. Date: May 21, 2020

(54) CONTROL SYSTEM FOR THE AUTOMATED MOVEMENT OF A MOTOR VEHICLE, METHOD AND COMPUTER PROGRAM

(71) Applicant: Dr. Ing. h.c. F. Porsche Aktiengesellschaft, Stuttgart (DE)

(72) Inventors: Philipp Eiber, Schorndorf (DE); Witali Schlecht, Neu-Ulm (DE); Sascha Tittelwitz, Hemmingen (DE); Christian Brombach, Ludwigsburg (DE)

(21) Appl. No.: 16/690,411

(22) Filed: Nov. 21, 2019

(30) Foreign Application Priority Data
Nov. 21, 2018 (DE) 10 2018 129 270.8

(51) Int. Cl. G05D 1/02; G05D 1/00

(52) U.S. Cl. CPC G05D 1/0234; G05D 2201/0213; G05D 1/0214; G05D 1/0088

(57) ABSTRACT

A control system (1) is provided for automated movement of a motor vehicle (2) from a first position (11) on a production site (10) to a second position (12) on the production site (10). The first position (11) and the second position (12) are connected to one another by a path (3) that has optical boundary markers (4). The control system (1) further may have an optical sensor (5) on the motor vehicle (2) and configured to detect the optical boundary markers (4)

### CROSS REFERENCE TO RELATED APPLICATION

This application claims priority under 35 USC 119 to German Patent Appl. No. 10 2018 129 270.8 filed on Nov. 21, 2018, the entire disclosure of which is incorporated herein by reference.

### BACKGROUND

Filed of the Invention. The present invention relates to a control system for the automated movement of a motor vehicle from a first position on a production site to a second position on the production site, wherein the first position and the second position are connected to one another with the aid of a path. The invention also relates to a method and to a computer program.

Related Art. Assembled motor vehicles typically are moved on a production site manually, for example by an assembly device, to a loading position.

DE 10 2016 001 814 A1 discloses a control apparatus for automated movement of a motor vehicle. The control apparatus comprises a control device for automated actuation of vehicle-side control units for the longitudinal and transverse control of the motor vehicle from a prescribable starting position to a prescribable target position.

It is an object of the invention to provide a control system for automated movement of a motor vehicle on a production site in a way that increases safety and/or decreases costs.

### SUMMARY

The invention relates to a control system for automated movement of a motor vehicle from a first position on a production site to a second position on the production site. The first and second positions are connected to one another with the aid of a path that has optical boundary markers.

The safety of an automated movement of a motor vehicle on a production site can be increased through the use of optical boundary markers so that accidents and other incidents can be prevented.

According to one embodiment, the motor vehicle comprises an optical sensor, and the optical boundary markers can be detected with the aid of the optical sensor. As a result, the motor vehicle can detect the boundary markers. According to embodiments of the invention, a wide range of optical sensors can be used.

A travel route for the motor vehicle from the first position to the second position may be determined with the aid of the optical boundary markers. The optical boundary markers can in this case mark the provided travel route. The optical boundary markers may be arranged on both sides of the travel route and delimit the travel route on both sides.

The first position may be associated with a first motor vehicle manufacturing step, and the second position may be associated with a second motor vehicle manufacturing step, wherein the second motor vehicle manufacturing step is a production step that follows the first motor vehicle manufacturing step.

The travel route may comprise or determine a loading transport track, such as a track to a loading device. As an alternative or in addition, it is conceivable that the travel route comprises or determines a post-treatment transport track. The travel route also may comprise or determine automated reloading. Additionally, the travel route may comprise or determine a transport track to a test track and/or away from a test track. Alternatively, or additionally, the travel route may comprise or determine an indoor transport track. The travel route also may comprise or determine automated loading, such as a track that is covered when the motor vehicle is loaded or during a loading process. The travel route may comprise or determine a test track so that an automated test travel is able to be carried out.

The motor vehicle may be designed not to exceed a maximum speed during a movement on the path, such as on the entire production site. The maximum speed may 15 km/h, or preferably 10 km/h, or more preferably 5 km/h. As a result, a particularly high level of safety can be achieved. The maximum speed may correspond to a step speed.

The control system may comprise a central controller that is designed for communication and control signal transmission to the motor vehicle, in particular with the aid of a wireless radio technology, such wireless local area network, WLAN. The central controller may be a central controller outside of the vehicle, such as a central device of the production site. With the aid of a wireless radio technology and a corresponding communication device on the motor vehicle, information can be exchanged between the central controller and the motor vehicle, such as from the motor vehicle to the central controller as well as from the central controller to the motor vehicle). The exchanged information may be control information or monitoring information.

In one embodiment, the motor vehicle comprises a sensor device, such as a mid-range radar sensor, MRR, and/or a nano radar. With this embodiment, an obstacle, such as a person and/or an object, in the surroundings of the motor vehicle, in particular in the driving direction, can be detected with the aid of the sensor device. Driverless transport system (DTS) test bodies on the production site or unexpected obstacles along the path can be identified by the motor vehicle in this way to achieve a particularly high level of accident safety. Various sensor types can be used, such as sensor types operating in the non-visible spectrum or in the visible spectrum.

The invention also relates to a method for the automated movement of a motor vehicle from a first position on a production site to a second position on the production site. The first position and the second position may be connected to one another via a path that has optical boundary markers.

The method may be carried out so that a travel route for the motor vehicle from the first position to the second position is determined with the aid of the optical boundary markers so that the motor vehicle is moved in an automated manner from the first position to the second position along the travel route.

The invention also relates to a computer program comprising commands, which, when the computer program is executed by a computer and/or a control system according to an embodiment of the invention, prompt the computer and/or the control system to execute a method according to an embodiment of the invention.

The same configurations, advantages and effects that have already been described in connection with the control system according to the invention or one embodiment of the control system according to the invention can be used in the method of the invention and the computer program of the invention.

Further details, features and advantages of the invention will emerge from the drawings and from the following description of preferred embodiments on the basis of the drawings. The drawings illustrate merely exemplary embodiments of the invention and do not restrict the concept of the invention.

### BRIEF DESCRIPTION OF DRAWINGS

FIG. 1 is a schematic illustration of a control system according to one embodiment of the invention.

FIG. 2 is a schematic illustration of a control system according to one embodiment of the invention.

FIG. 3 is a schematic illustration of a control system according to one embodiment of the invention.

FIG. 4 is a schematic illustration of a control system according to an embodiment of the invention.

### DETAILED DESCRIPTION

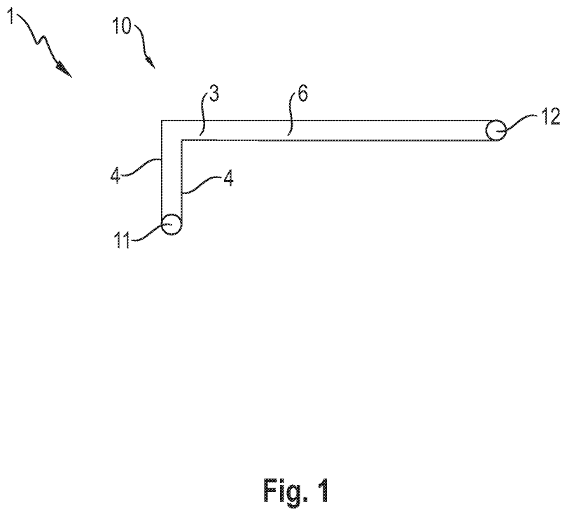

FIG. 1 is a schematic illustration of a control system 1 according to an embodiment of the invention. The control system 1 is designed to control automated movement of a motor vehicle 2 from a first position 11 on a production site 10 to a second position 12 on the production site 10. The first position 11 and the second position 12 are connected to one another with the aid of a path 3. Optical boundary markers 4 are installed on the path 3 and determine a travel route 6 for the motor vehicle from the first position 11 to the second position 12. The boundary markers 4 are arranged on both sides along the travel route 6. The motor vehicle 2 is designed for autonomous driving or driverless driving. The motor vehicle 2 may move along the travel route 6 at a maximum speed of equal to or less than 15 km/h, preferably equal to or less than 10 km/h, particularly preferably of equal to or less than 5 km/h. In particular, provision may be made for the motor vehicle not to exceed the step speed during automated movement thereof.

The first position 11 is associated with a first motor vehicle manufacturing step and the second position 12 is associated with a second motor vehicle manufacturing step. The second motor vehicle manufacturing step is in this case preferably a production step or manufacturing step that follows the first motor vehicle manufacturing step. The travel route 6 may comprise a loading transport track from a first position 11 to a second position 12. The second position 12 may be arranged at a loading device. As an alternative or in addition, the travel route 6 may comprise a post-treatment transport track. As an alternative or in addition, the travel route 6 may comprise automated reloading. The travel route 6 also may comprise a transport track to a test track and/or away from a test track. For example, the travel route 6 may comprise an indoor transport track, such as a hangar. As an alternative or in addition, the travel route 6 may comprise a track that is covered when the motor vehicle is loaded so that an at least partly automated loading process is able to be carried out with the aid of the travel route. The travel route 6 may comprise a test track so that an automated test travel is able to be carried out.

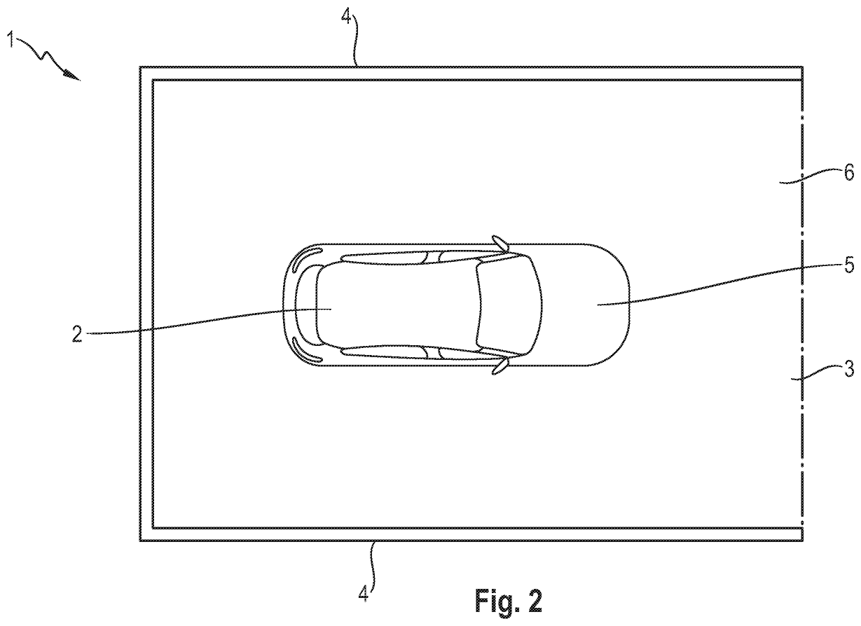

FIG. 2 is a schematic illustration of a control system 1 with a motor vehicle 2 located at the first position 11 on the path 3 within the optical boundary markers 4 or lane markings that determine the travel route 6. The motor vehicle 2 comprises one or more optical sensors 5. The motor vehicle 2 can identify the optical boundary markers 4 and can follow the provided travel route 6 with the aid of the optical sensor 5 or of the optical sensors 5.

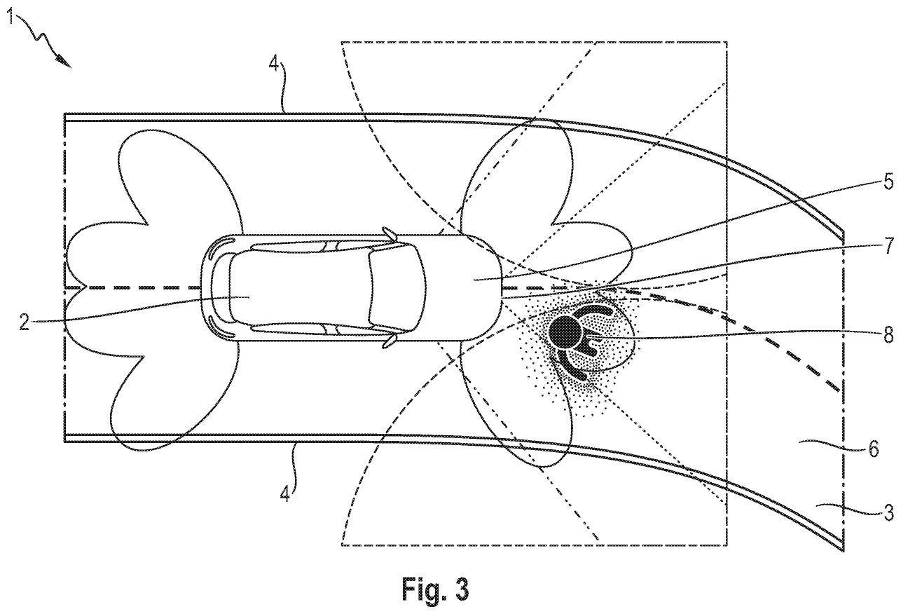

FIG. 3 is a schematic illustration of a control system 1 according to another embodiment of the invention. Similar to FIG. 2, the motor vehicle 2 is located on the path 3 on which the travel route 6 is determined with the aid of the optical boundary markers 4. The motor vehicle 2 comprises one or more optical sensors 5 for detecting the boundary markers 4. The motor vehicle 2 also comprises at least one sensor device 7 with a mid-range radar sensor, MRR, and/or a nano radar. An obstacle 8 located on the provided travel route 6, for example a person and/or an object, can be identified with the aid of the sensor device 7. If an obstacle 8 is identified, countermeasures can be introduced to prevent a collision or accident. Purely vehicle-based obstacle identification can be provided with the aid of the sensor device 7.

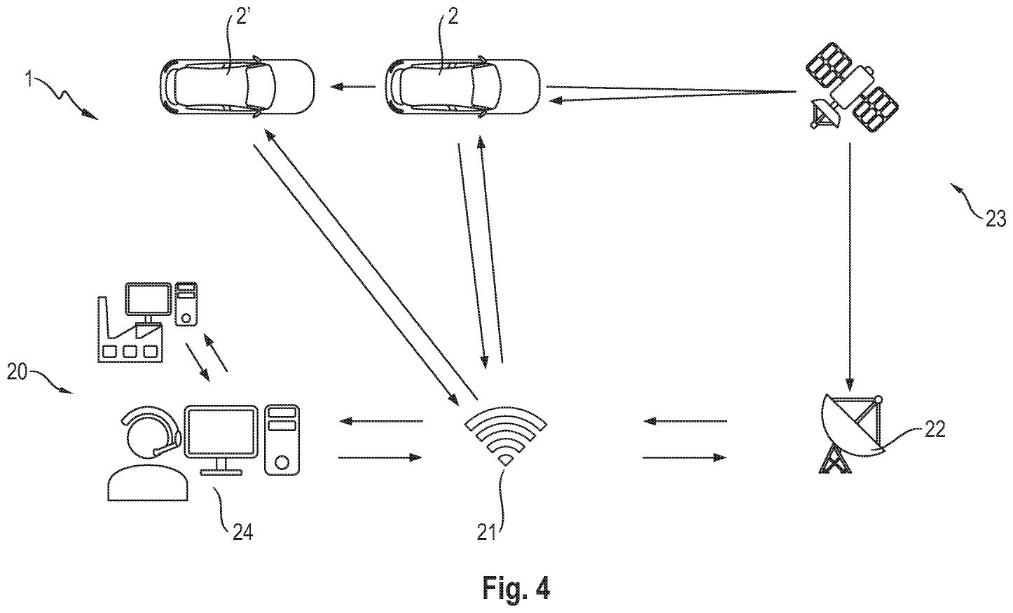

FIG. 4 is another schematic illustration of a control system 1 according to an embodiment of the invention. In particular, a back end of the control system 1 is illustrated. The control system 1 comprises a central controller 20. Communication between the central controller 20 and the motor vehicle 2 or further motor vehicles 2′ can be provided with the aid of a wireless radio technology 21, in particular WLAN, such that a parallel operation of a plurality of vehicles 2, 2′ is possible. A redundant control center, in particular comprising redundant and separate computation hardware, can be configured for this purpose. The communication with the motor vehicles 2, 2′ or the control thereof can be performed by operator control personnel 24. A global navigation satellite system 23, GNSS 23, can also be used for the navigation of the motor vehicles 2, 2′. A GNSS correction can be implemented with the aid of a base station 22 of the GNSS 23 at a known position.

What is claimed is:

1. A control system for automated movement of a motor vehicle from a first position on a production site to a second position on the production site, the first position and the second position are connected to one another by a path that has optical boundary markers.

2. The control system of claim 1, further comprising an optical sensor on the motor vehicle and configured to detect the optical boundary markers.

3. The control system of claim 2, wherein a travel route for the motor vehicle from the first position to the second position is determined with the aid of the optical boundary markers.

4. The control system of claim 1, wherein the first position is associated with a first motor vehicle manufacturing step, and the second position is associated with a second motor vehicle manufacturing step that follows the first motor vehicle manufacturing step.

5. The control system of claim 1, wherein the motor vehicle is controlled not to exceed a maximum speed during a movement on the path, in particular on the entire production site.

6. The control system of claim 1, wherein the control system (1) comprises a central controller (20) configured for communication and control signal transmission to the motor vehicle (2) via a wireless local area network, WLAN.

7. The control system of claim 1, further comprising comprising a sensor device on the motor vehicle and configured to detect an obstacle in proximity to the motor vehicle.

8. A method for the automated movement of a motor vehicle from a first position on a production site to a second position on the production site, wherein the first position and the second position are connected to one another with the aid of a path that has optical boundary markers.

9. The method of claim 8, wherein a travel route for the motor vehicle from the first position to the second position is determined with the aid of the optical boundary markers, wherein the motor vehicle is moved in an automated manner from the first position to the second position along the travel route.

10. A computer program comprising commands, which, when the computer program is executed by a computer prompts the computer and/or the control system to execute the method of claim 9.
